(19) United States
(12) Patent Application Publication
(10) Pub. No.: US 2005/0083259 A1
(43) Pub. Date: Apr. 21, 2005

(54) Driving device and method of plasma display panel

(76) Inventors: Jin-Sung Kim, Suwon-si (KR); Byung Hak Lee, Suwon-si (KR); Seung-Hun Chae, Suwon-si (KR)

Correspondence Address: MCGUIREWOODS, LLP, 1750 TYSONS BLVD, SUITE 1800, MCLEAN, VA, 22102, US

(21) Appl. No.: 10/963,638

(22) Filed: Oct. 14, 2004

(30) Foreign Application Priority Data
Oct. 16, 2003 (KR) 10-2003-0072338

(51) Int. Cl. G09G 3/28

(52) U.S. Cl. 345/60

(57) ABSTRACT

A method of driving a plasma display panel having a discharge space formed by at least two electrodes is disclosed. In a reset period, the method includes changing a voltage of a first electrode by a first voltage to discharge the discharge space; floating the first electrode during a first period after changing the voltage of the first electrode by the first voltage; changing the voltage of the first electrode by a second voltage in a opposite direction of the first voltage after the first period; and floating the first electrode during the second period after changing the voltage of the first electrode by the second voltage. These steps may be repeated.

### CROSS REFERENCE TO RELATED APPLICATION

This application claims priority to and the benefit of Korean Patent Application No. 10-2003-0072338 filed on Oct. 16, 2003 in the Korean Intellectual Property Office, the contents of which are herein incorporated by reference in their entirety.

### BACKGROUND OF THE INVENTION

1. Field of the Invention

The present invention relates to a driving device and method of a driving plasma display panel (PDP) and plasma display device.

2. Description of the Related Art

A PDP is a flat display for displaying characters or images using a plasma generated by gas discharge and several tens to several millions of pixels that are arranged in a matrix format on the PDP according to the PDP size. The PDP is classified as either a DC PDP or an AC PDP depending on waveforms of applied driving voltages and configurations of discharge cells.

In general, the AC PDP driving method uses a reset period, an address period, and a sustain period with respect to temporal operation variations. During the reset period, wall charges formed by a previous sustain are erased, and each cell is reset so as to fluently perform a next address operation. During the address period, cells that are turned on and those that are not turned on are selected, and the wall charges are accumulated on the turned-on cells (i.e., addressed cells). During the sustain period, a discharge for displaying images to the addressed cells is executed. When the sustain period starts, sustain pulses are alternately applied to the scan electrodes and sustain electrodes to thus perform sustaining and display the images.

Conventionally, a ramp waveform is applied to a scan electrode so as to establish wall charges in the reset period, as disclosed in U.S. Pat. No. 5,745,086. That is, a rising ramp waveform which gradually rises is applied to the scan electrode, and a falling ramp waveform which gradually falls is therefore applied thereto. The wall charges are not finely controlled within a predetermined time frame because precision control of the wall charges varies greatly depending on the gradient of the ramp.

### SUMMARY OF THE INVENTION

In the present invention, there is provided a driving device and method for driving a PDP to precisely control wall charges. For example, one embodiment controls wall changes by repeating a repeats falling voltage of an electrode and then floats the electrode.

In one aspect of the present invention, a driving device of a plasma display panel is provided that has a discharge space formed by at least two electrodes. In a reset period, one embodiment of a driving method includes: changing a voltage of the first electrode by a first voltage to discharge a discharge space; floating the first electrode during a first period after changing the voltage of the first electrode by the first voltage; changing the voltage of the first electrode by a second voltage in an opposite direction of the first voltage after the first period; floating the first electrode during the second period after changing the voltage of the first electrode by the second voltage. According to an exemplary embodiment of the present invention, the driving method is repeated a predetermined number of times.

In another aspect of the present invention, there is provided a method of driving the plasma display panel wherein a discharge space is formed by at least two electrodes. The driving method includes changing the voltage of the first electrode of electrodes forming the discharge space by the first voltage; floating the first electrode; and changing the voltage of the first electrode by the second voltage.

Another aspect of the present invention provides a method of driving a plasma display panel having a discharge space formed by at least two electrodes acting as a capacitive load. The driving device includes a first driving circuit that reduces the voltage of a first electrode in electrodes forming the capacitive load by a first voltage, then floating the first electrode; and a second driving circuit increasing the voltage of the first electrode by a second voltage, then floating the first electrode, wherein the first driving circuit and the second driving circuit operate by turns.

According to an exemplary embodiment of the present invention, the first driving circuit includes a first transistor having a first end coupled to the first electrode and a second end coupled to a first power source supplying a third voltage. The second driving circuit includes a second transistor having its first end coupled to a second power source supplying a fourth voltage higher than the third voltage and its second end coupled to the first electrode. In the second driving electrode, the voltage of the first electrode can be between the third voltage and fourth voltage in some period.

According to other exemplary embodiment of the present invention, in a first period during which while the second transistor is turned off, the first transistor is turned on so that the voltage of the first electrode decreases to the first voltage, and then the first transistor is turned off; and in a second period during which while the first transistor is turned off, the second transistor is turned on so that the voltage of the first electrode increases to the second voltage, and then the second transistor is turned off. These cycles are then repeated.

According to another exemplary embodiment of the present invention, the first transistor turns on in response to a first level of a control signal having a first level and a second level alternately. The first driving circuit further comprises a capacitor which is coupled between the second end of the first transistor and the first power source to receive the charge from the first electrode when the first transistor turns on, and a discharge path which discharges at least a portion of charge charged to the capacitor in response to the second level of the control signal. Also, the first transistor turns off when the voltage of the first electrode is reduced by the first voltage and the predetermined charge is charged to the capacitor.

According to another exemplary embodiment of the present invention, the second transistor turns on in response to a first level of a control signal having the first level and a second level alternately. The second driving circuit further comprises a capacitor which is coupled between the second end of the second transistor and the first electrode and receive the charge from the second power source when the second transistor turns on, and a discharge path which discharges at least a portion of charge charged to the capacitor in response to the second level of the control signal; and the second transistor turns off when the voltage of the first electrode rises by the second voltage and the predetermined charge is charged to the capacitor.

According to another exemplary embodiment of the present invention, the first transistor turns on in response to a first level of a control signal having the first level and a second level alternately. The first driving circuit further comprises a capacitor which is coupled between an input end to which the control signal is inputted and a control end of the first transistor. A resistor is formed in the path that includes the input end, the capacitor, and the control end of the first transistor. A discharge path discharges voltage charged to the capacitor in response to the second level of the control signal. The first transistor turns off when the predetermined voltage charges to the capacitor in response to the first level of the control signal.

According to another exemplary embodiment of the present invention, the second transistor turns on in response to a first level of a control signal having the first level and a second level alternately. The second driving circuit further comprises a capacitor which is coupled between an input end to which the control signal is inputted and a control end of the second transistor. A resistor is formed in the path that includes the input end, the capacitor, and the control end of the second transistor. A discharge path discharges voltage charged to the capacitor in response to the second level of the control signal. The second transistor turns off when the predetermined voltage charges to the capacitor in response to the first level of the control signal.

According to another exemplary embodiment of the present invention, the first transistor turns on in response to a first level of a control signal having the first level and a second level alternately. The first driving circuit further comprises a capacitor which is coupled between an input end to which the control signal is inputted and the control end of the first transistor. At least one element of a resistor and an inductor are formed in the path that includes the input end, the capacitor, and the control end of the first transistor. The first transistor turns off when the predetermined voltage charges to the capacitor in response to the first level of the control signal.

According to another exemplary embodiment of the present invention, the second transistor turns on in response to a first level of a control signal having the first level and a second level alternately. The second driving circuit further comprises a capacitor which is coupled between an input end to which the control signal is inputted and the control end of the first transistor. At least one element of a resistor and an inductor is formed in the path that includes the input end, the capacitor, and the control end of the second transistor. The second transistor turns off when the predetermined voltage charges to the capacitor in response to the first level of the control signal.

### BRIEF DESCRIPTION OF THE DRAWINGS

FIG. 1 shows a brief diagram of a PDP according to an exemplary embodiment of the present invention.

FIG. 2 shows a driving waveform diagram of the PDP according to an exemplary embodiment of the present invention.

FIG. 3 shows a falling waveform and a discharge current according to an exemplary embodiment of the present invention.

FIG. 4A shows a modeled diagram of a discharge cell formed by a sustain electrode and a scan electrode.

FIG. 4B shows an equivalent circuit of FIG. 4A.

FIG. 4C shows an embodiment when no discharge occurs in the discharge cell of FIG. 4A.

FIG. 4D shows a state where a voltage is applied when a discharge occurs in the discharge cell of FIG. 4A.

FIG. 4E shows a floated state when a discharge occurs in the discharge cell of FIG. 4A.

FIG. 5 shows a falling waveform of a plasma display panel a second exemplary embodiment.

FIG. 6 shows a falling waveform of the plasma display panel according to a third exemplary embodiment of the present invention.

FIG. 7 shows a rising waveform of the plasma display panel according to a exemplary embodiment of the present invention.

FIG. 8 shows a brief circuit diagram of the driving circuit according to a exemplary embodiment of the present invention.

FIG. 9 shows a driving waveform diagram for driving the driving circuit of FIG. 8.

FIGS. 10, 11, 13, 14, 15, and 16 show brief circuit diagrams of driving circuits according to other exemplary embodiments of the present invention, respectively.

FIG. 12 shows a relation between a control signal and a voltage of a capacitor in circuit of FIG. 11.

### DETAILED DESCRIPTION

In the following detailed description, only certain exemplary embodiments of the present invention are shown and described, by way of illustration. As those skilled in the art will recognize, the described exemplary embodiments may be modified in various ways, all without departing from the spirit or scope of the present invention. Accordingly, the drawings and description are to be regarded as illustrative in nature, and not restrictive.

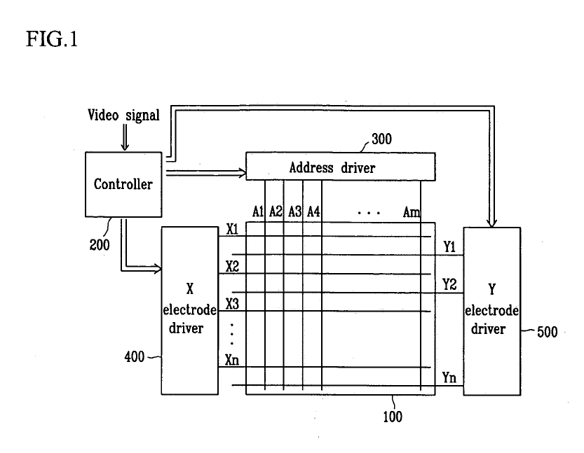

FIG. 1 shows a brief diagram of a plasma display device according to an exemplary embodiment of the present invention. As shown, the plasma display device includes a PDP 100, a controller 200, an address driver 300, a sustain electrode driver (referred to as an X electrode driver hereinafter) 400, and a scan electrode driver (referred to as a Y electrode driver hereinafter) 500.

The PDP 100 includes a plurality of address electrodes A₁ to Aₘ extended in the column direction, a plurality of sustain electrodes (referred to as X electrodes hereinafter) X₁ to Xₙ extended in the row direction, and a plurality of scan electrodes (referred to as Y electrodes hereinafter) Y₁ to Yₙ extended in the row direction. The X electrodes X₁ to Xₙ are formed corresponding to the respective Y electrodes Y₁ to Yₙ, and their ends are connected in common. Discharge spaces on the crossing points of the address electrodes A₁ to Aₘ and the X and Y electrodes X₁ to Xₙ and Y₁ to Yₙ form discharge cells.

The controller 200 externally receives video signals, and outputs address driving control signals, X electrode driving control signals, and Y electrode driving control signals. Also, the controller 200 divides a single frame into a plurality of subfields and drives them. Each subfield includes a reset period, an address period, and a sustain period with respect to temporal operation variations.

The address driver 300 receives address driving control signals from the controller 200, and applies display data signals for selecting desired discharge cells to the respective address electrodes A₁ to Aₘ. The X electrode driver 400 receives X electrode driving control signals from the controller 200, and applies driving voltages to the X electrodes X₁ to Xₙ, and the Y electrode driver 500 receives Y electrode driving control signals from the controller 200, and applies driving voltages to the Y electrodes Y₁ to Yₙ.

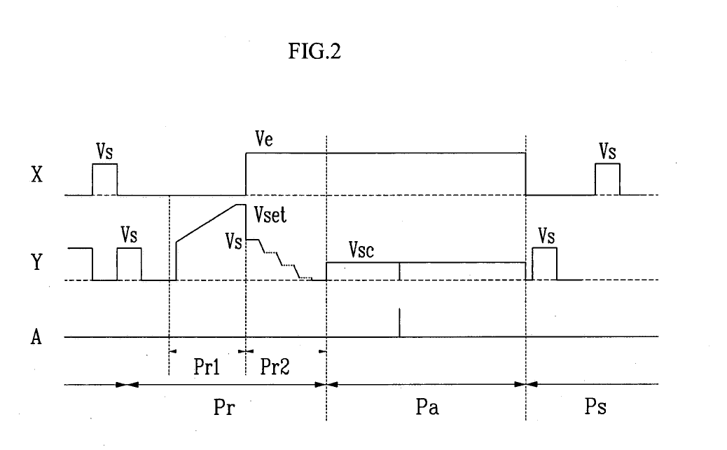

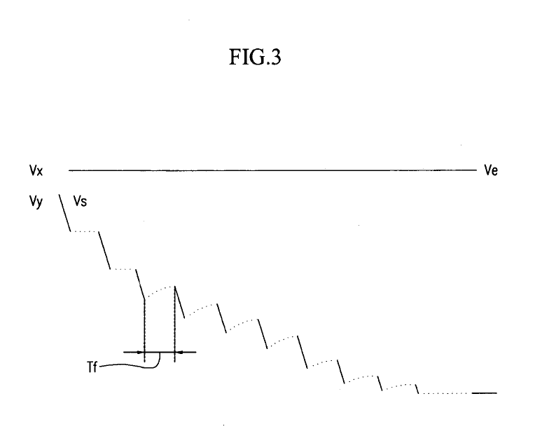

Referring to FIGS. 2 and 3, driving waveforms applied to the address electrodes A₁ to Aₘ, the X electrodes X₁ to Xₙ, and the Y electrodes Y₁ to Yₙ for each subfield wiH be described. A discharge cell formed by an address electrode, an X electrode, and a Y electrode will be described below. FIG. 2 shows a driving waveform diagram of a PDP according to the first exemplary embodiment of the present invention, and FIG. 3 shows a voltage of a electrode and a discharge current obtained by a driving waveform according to a first exemplary embodiment of the present invention.

Referring to FIG. 2, a single subfield includes a reset period Pᵣ, an address period Pₐ, and a sustain period P₅, and the reset period Pᵣ includes a rising period Pᵣ₁, and a falling period Pᵣ₂.

A rising waveform from a voltage of Vᵣ to a voltage of Vₛₑₜ is applied to the Y electrode while the X electrode is maintained at 0V in the rising period Pᵣ₁ of the reset period Pr. Weak reset discharging is generated to the address electrode and the X electrode from the Y electrode, and negative charges are accumulated at the Y electrode, while positive charges are accumulated at the address electrode and the X electrode.

As shown in FIGS. 2 and 3, falling/floating voltages are applied and a process is repeated in which the voltage applied to the Y electrode is reduced by a predetermined voltage from Vₛ voltage to Vₙ voltage and the Y electrode is floated, while the X electrode is maintained at the voltage of Vₑ in the falling period Pᵣ₂ of the reset period Pᵣ. That is, the Y electrode is floated by stopping the voltage applied to the Y electrode during the period of T_{f}, after the voltage applied to the Y electrode is rapidly reduced by a predetermined amount. And this process is repeated.

When a voltage difference between the voltage Vₓ at the X electrode and the voltage V_{y} at the Y electrode becomes greater than a discharge firing voltage V_{f} while repeating this process, a discharge occurs between the X and Y electrodes. That is, a discharge current flows in the discharge space. When the Y electrode is floated after the discharge begins between the X and Y electrodes, wall charges formed in X and Y electrodes are decreased, and the interval voltage of the discharge space is rapidly reduced so that an intense discharge quenching occurs in the discharge space. Next, when the Y electrode is floated after generating a discharge by applying a falling voltage to Y electrode, the wall charges are reduced and an intense discharge quenching occurs in the discharge space as in the above case. When applied falling voltage and floating voltage are repeated a predetermined number of times, desired amounts of wall charges are formed at the X and Y electrodes.

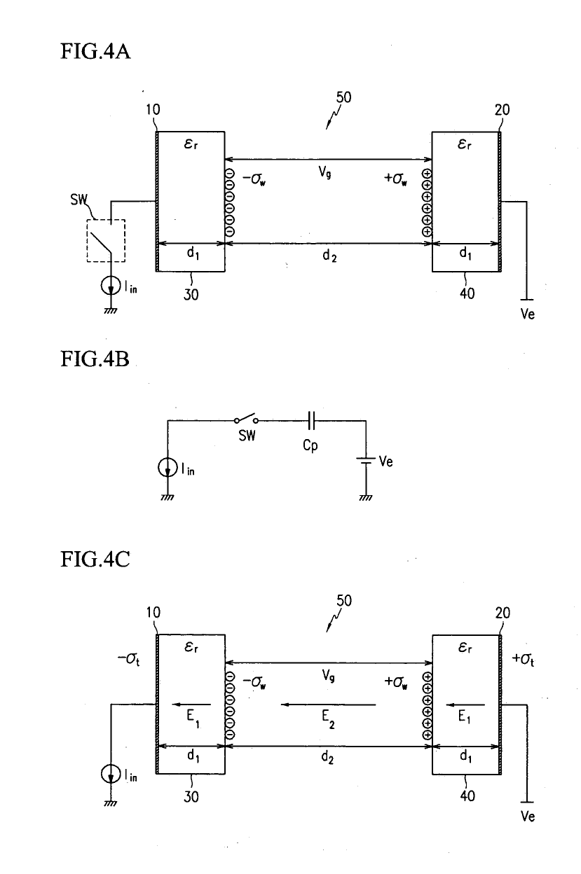

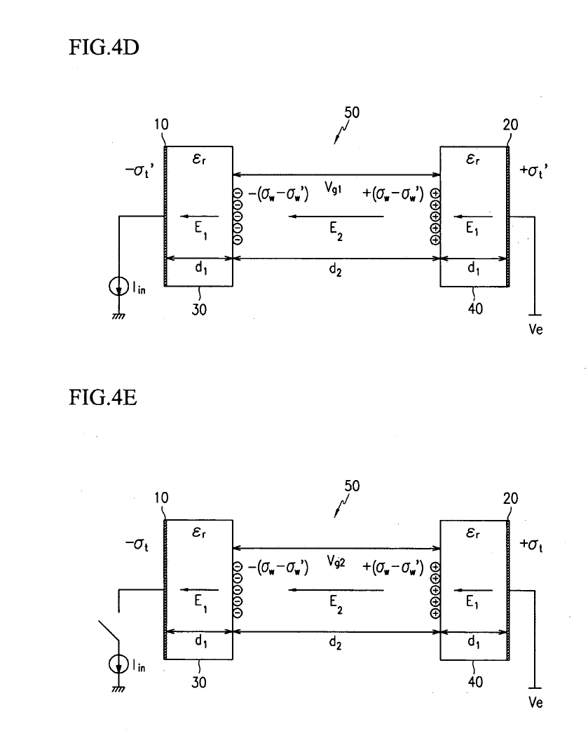

Referring to FIGS. 4A to 4E, the intense discharge quenching caused by floating will be described below in detail with reference to the X and Y electrodes in the discharge cell, since the discharge generally occurs between the X and Y electrodes.

FIG. 4A shows a modeled diagram of a discharge cell formed by a sustain electrode and a scan electrode, FIG. 4B shows an equivalent circuit of FIG. 4A. FIG. 4C shows an embodiment when no discharge occurs in the discharge cell of FIG. 4A. FIG. 4D shows a state in which a voltage is applied when a discharge occurs in the discharge cell of FIG. 4A. And FIG. 4E shows a floated state when a discharge occurs in the discharge cell of FIG. 4A. For ease of description, charges −σ_{w} and +σ_{w} are respectively formed at the Y and X electrodes 10 and 20 in the earlier stage in FIG. 4A. The charges are formed on a dielectric layer of an electrode, but for ease of explanation, are described as being formed at the electrode.

As shown in FIG. 4A, the Y electrode 10 is connected to a current source Iᵢₙ through a switch SW, and the X electrode 20 is connected to the voltage of Vₑ. Dielectric layers 30 and 40 are respectively formed within the Y and X electrodes 10 and 20. Discharge gas (not shown) is injected between the dielectric layers 30 and 40, and the area provided between the dielectric layers 30 and 40 forms a discharge space 50.

Since the Y and X electrodes 10 and 20, the dielectric layers 30 and 40, and the discharge space 50 form a capacitive load, they can be represented as a panel capacitor Cₚ as shown in FIG. 4B. It is defined such that the dielectric constant of the dielectric layers 30 and 40 is er, a voltage at the discharge space 50 is Vg, the thickness of the dielectric layers 30 and 40 is the same as d1, and the distance (the width of the discharge space) between the dielectric layers 30 and 40 is d₂.

The voltage of V_{y} applied to the Y electrode of the panel capacitor Cₚ is reduced in proportion to the time when the switch SW is turned on as given in Equation 1. That is, when the switch SW is turned on, a falling voltage is applied to the Y electrode 10. Although the falling voltage is applied to the Y electrode 10 by current source Iᵢₙ in FIG. 4A, the voltage of the Y electrode 10 can be directly reduced.

$${V}_{y} = {V}_{y} ( 0 ) - \frac{{I}_{in}}{{C}_{p}} t \qquad Equation 1$$

where V_{y}(0) is a Y electrode voltage V_{y} when the switch SW is turned on, and Cₚ is capacitance of the panel capacitance Cₚ.

Referring to FIG. 4C, the voltage V_{g} applied to the discharge space 50 when no discharge occurs while the switch SW is turned on is calculated, assuming that the voltage applied to the Y electrode 10 is Vᵢₙ.

When the voltage of Vᵢₙ is applied to the Y electrode 10, the charges −σₜ are applied to the Y electrode 10, and the charges +σₜ are applied to the X electrode 20. By applying the Gaussian theorem, the electric field E₁ within the dielectric layers 30 and 40 and the electric field E₂ within the discharge space 50 are given as Equations 2 and 3.

$${E}_{1} = \frac{{σ}_{t}}{{ɛ}_{r} {ɛ}_{0}} \qquad Equation 2$$

where σₜ is charges applied to the Y and X electrodes, and ε₀ is a permittivity within the discharge space.

$${E}_{2} = \frac{{σ}_{t} + {σ}_{w}}{{ɛ}_{0}} \qquad Equation 3$$

The voltage of (Vₑ−Vᵢₙ) applied outside is given as Equation 4 according to a relation between the electric field and the distance, and the voltage of V_{g} of the discharge space 50 is given as Equation 5.
2dᵢE₁+d₂E₂=Vₑ−Vᵢₙ Equation 4
V_{g}=d₂E₂ Equation 5

From Equations 2 to 5, the charges σₜ applied to the X or Y electrode 10 or 20 and the voltage V_{g} within the discharge space 50 are respectively given as Equations 6 and 7.

$${σ}_{t} = \frac{{V}_{e} - {V}_{in} - \frac{{d}_{2}}{{ɛ}_{0}} {σ}_{w}}{\frac{{d}_{2}}{{ɛ}_{0}} + \frac{2 {d}_{1}}{{ɛ}_{r} {ɛ}_{0}}} = \frac{{V}_{e} - {V}_{in} - {V}_{w}}{\frac{{d}_{2}}{{ɛ}_{0}} + \frac{2 {d}_{1}}{{ɛ}_{r} {ɛ}_{0}}} \qquad Equation 6$$

where V_{w} is a voltage formed by the wall charges σ_{w} in the discharge space 50.

$${V}_{g} = \frac{{ɛ}_{r} {d}_{2}}{{ɛ}_{r} {d}_{2} + 2 {d}_{1}} ( {V}_{e} - {V}_{in} - {V}_{w} ) + {V}_{w} = α ( {V}_{e} - {V}_{in} ) + ( 1 - α ) {V}_{w} \qquad Equation 7$$

Actually, since the internal length d₂ within the discharge space 50 is a very large value compared to the thickness d₁ of the dielectric layers 30 and 40, α almost reaches 1. That is, it is known from Equation 7 that the externally applied voltage of (Vₑ−Vᵢₙ) is applied to the discharge space 50.

Next, referring to FIG. 4D, the voltage V_{g1} within the discharge space 50 when the wall charges formed at the Y and X electrodes 10 and 20 is quenched by the amount of UV because of the discharge caused by the externally applied voltage of (Vₑ−Vᵢₙ) is calculated. The charges applied to the Y and X electrodes 10 and 20 are increased to αₜ′ since the charges are supplied from the power Vᵢₙ so as to maintain the potential of the electrodes when the wall charges are formed.

By applying the Gaussian theorem in FIG. 4D, the electric field E₁ within the dielectric layers 30 and 40 and the electric field E₂ within the discharge space 50 are given as Equation 8 and 9.

$$\begin{matrix}{E}_{1} = \frac{{σ}_{t}^{′}}{{ɛ}_{r} {ɛ}_{0}} & Equation 8 \\ {E}_{2} = \frac{{σ}_{t}^{′} + {σ}_{w} - {σ}_{w}^{′}}{{ɛ}_{0}} & Equation 9\end{matrix}$$

From Equations 8 and 9, the charges σₜ′ applied to the Y and X electrodes 10 and 20 and the voltage V_{g1} within the discharge space is given as Equations 10 and 11.

$$\begin{matrix}{σ}_{t}^{′} = \frac{{V}_{e} - {V}_{in} - \frac{{d}_{2}}{{ɛ}_{0}} ( {σ}_{w} - {σ}_{w}^{′} )}{\frac{{d}_{2}}{{ɛ}_{0}} + \frac{2 {d}_{1}}{{ɛ}_{r} {ɛ}_{0}}} = \frac{{V}_{e} - {V}_{in} - {V}_{w} + \frac{{d}_{2}}{{ɛ}_{0}} {σ}_{w}^{′}}{\frac{{d}_{2}}{{ɛ}_{0}} + \frac{2 {d}_{1}}{{ɛ}_{r} {ɛ}_{0}}} & Equation 10 \\ {V}_{g1} = {d}_{2} {E}_{2} = α ( {V}_{e} - {V}_{in} ) + ( 1 - α ) {V}_{w} - ( 1 - α ) \frac{{d}_{2}}{{ɛ}_{0}} {σ}_{w}^{′} & Equation 11\end{matrix}$$

Since α is almost 1 in Equation 11, very little voltage falling is generated within the discharge space 50 when the voltage Vᵢₙ is externally applied to generate a discharge. Therefore, when the amount σ_{w}′ of the wall charges reduced by the discharge is very large, the voltage V_{g1} within the discharge space 50 is reduced, and the discharge is quenched.

Next, referring to FIG. 4E, the voltage V_{g2} within the discharge space 50 when the switch SW is turned off (i.e., the discharge space 50 is floated) after the wall charges formed at the Y and X electrodes 10 and 20 are quenched by the amount of σ_{w}′, because of the discharge caused by the externally applied voltage Vᵢₙ, is calculated. Since no external charges are applied, the charges applied to the Y and X electrodes 10 and 20 become at in the same manner of FIG. 4C. By applying the Gaussian theorem, the electric field E₁ within the dielectric layers 30 and 40 and the electric field E₂ within the discharge space 50 are given as Equation 2 and 12.

$${E}_{2} = \frac{{σ}_{t} + {σ}_{w} - {σ}_{w}^{′}}{{ɛ}_{0}} \qquad Equation 12$$

From Equations 12 and 6, the voltage V_{g2} of the discharge space 50 is given as Equation 13.

$${V}_{g1} = {d}_{2} {E}_{2} = α ( {V}_{e} - {V}_{in} ) + ( 1 - α ) {V}_{w} - \frac{{d}_{2}}{{ɛ}_{0}} {σ}_{w}^{′} \qquad Equation 13$$

It is known from Equation 13 that a large voltage fall is generated by the quenched wall charges when the switch SW is turned off (floated). That is, as known from Equations 12 and 13, the voltage falling intensity caused by the wall charges in the floated state of the electrode increases by a multiple of 1/(1−α) times that of the voltage applying state. As a result, since the voltage within the discharge space 50 is substantially reduced in the floated state when a small amount of charges are reduced, the voltage between the electrodes falls below the discharge firing voltage, and the discharge is steeply quenched. That is, the operation of floating the electrode after the discharge starts functions as an intense discharge quenching mechanism. When the voltage within the discharge space 50 is reduced, the voltage V_{y} at the floated Y electrode is increased by a predetermined voltage as shown in FIG. 3 since the X electrode is fixed at the voltage of Vₑ.

Referring to FIG. 3, when the Y electrode is floated in the case that the Y electrode voltage falls to cause a discharge, the discharge is quenched while the wall charges formed at the Y and X electrodes are a little reduced according to the discharge quenching mechanism. By repeating this operation, the wall charges formed at the Y and X electrodes are erased step by step to thereby control the wall charges to reach a desired state. That is, the wall charges are accurately controlled to achieve a desired wall charge state in the falling period Pᵣ₂ of the reset period Pr.

The first exemplary embodiment is described during the falling period Pᵣ₂ of the reset period Pᵣ, but without being restricted to this, the present invention is applicable to all cases of controlling the wall charges by using the falling ramp. Further the waveform in which the electrode voltage falls and the electrode is floated, was explained, however, the waveform in which the electrode voltage rises and the electrode is floated, also can be applied to the above quick quenching mechanism. That is, the process can be repeated in which the electrode voltage is raised and the electrode is floated, instead of applying the rising ramp voltage to the Y electrode in the rising period Pᵣ₁ of the reset period Pᵣ.

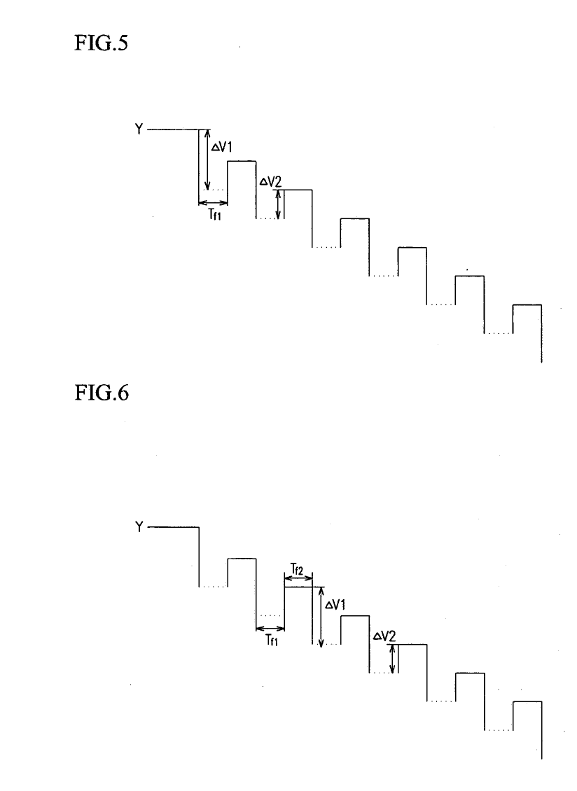

In the first exemplary embodiment of the present invention, the voltage in the discharge space 50 was reduced by floating the Y electrode, that is, the discharge was quenched by increasing the voltage of the Y electrode. In a case where the discharge cannot be quenched by floating the Y electrode, the voltage can be applied in the direction quenching discharge. Such exemplary embodiment is explained referring to FIG. 5.

FIG. 5 shows a falling waveform of a plasma display panel of a second exemplary embodiment. For convenience, the rising of the voltage of Y electrode by floating is not showed.

As shown in FIG. 5, in the falling waveform according to the second exemplary embodiment of the present invention, Y electrode voltage is reduced by the predetermined amount V₁, and the Y electrode is floated by stopping the voltage applied to the Y electrode. Then the Y electrode voltage is raised by the predetermined amount V₂. And the above process is repeated. In this timeframe, the voltage V₁ is greater than the voltage V₂.

In this manner, the voltage of the Y electrode is reduced by the voltage V₁ and discharge occurs, and Y electrode is floated, and the discharge is quickly stopped by raising the voltage of the Y electrode by the voltage V₂. Thus, it is possible to quench discharge over the first exemplary embodiment by raising the voltage of the Y electrode by the voltage V₂, and the falling range of the Y voltage V₁ can be enlarged. Further, since the discharge can be quenched certainly by raising the voltage of the Y electrode by the voltage V₂, the reset operation can be more stably operated in comparison with the first exemplary embodiment.

Further, the voltage of the Y electrode is raised by the voltage V₂, and then the voltage of the electrode is sustained during the predetermined period in FIG. 5, however the voltage of the Y electrode is raised and Y electrode can be floated in a different way. Such exemplary embodiment is explained in detail referring to FIG. 6.

FIG. 6 shows a falling waveform of the plasma display panel according to a third exemplary embodiment of the present invention. For convenience, the rising of the voltage of Y electrode by floating is not showed.

As shown in FIG. 6, in the falling waveform of the third exemplary embodiment of the present invention the voltage of the Y electrode is raised to V₂, and the electrode is floated during T_{f2} period. As such, the discharge can be more stably suppressed in comparison with the first exemplary embodiment by floating the Y electrode after raising the voltage of the Y electrode by the voltage V₂. That is, the strong discharge, which can be generated from sustaining the voltage during the predetermined period after the voltage of the Y electrode rises, can be prevented by floating.

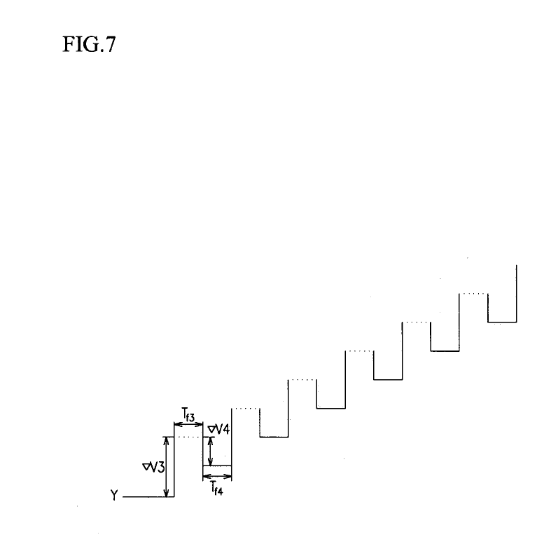

Further, though FIGS. 5 and 6 explain falling waveforms as does FIG. 4, the invention may be practiced using rising waveforms. FIG. 7 shows a rising waveform of the plasma display panel according to a exemplary embodiment of the present invention. As shown in FIG. 7, Y electrode voltage is raised by the predetermined amount V₃, and the Y electrode is floated by stopping the voltage applied to the Y electrode during Tf3 period, and then Y electrode voltage is reduced by the predetermined amount V₄ after floating the Y electrode, and then the Y electrode is floated during T_{f4}. And the above process is repeated. In here, the voltage V₃ is greater than the voltage V₄. Thus, the wall charge can be precisely controlled by quickly suppressing the discharge after generating discharge, as explained in the above falling waveform.

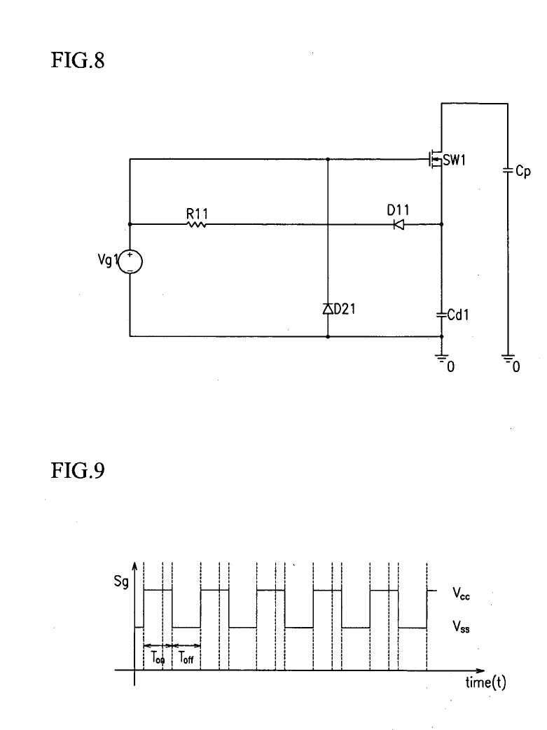

Hereinafter, a driving circuit which is configured to generate the above-explained waveforms is explained in detail referring to FIGS. 8, 9, 10, 11, 12, 13, 14, and 15. The driving circuit can be formed in the Y electrode driver 500.

First, the driving circuit which is configured to generate the falling waveform shown in FIG. 3 is explained referring to FIGS. 8 and 9.

FIG. 8 is a brief circuit diagram of the driving circuit according to a fourth exemplary embodiment. FIG. 9 is a driving waveform diagram for driving the circuit of depicted in FIG. 8. The panel capacitor Cₚ is a capacitive load formed between the Y electrode and X electrode as shown in FIG. 4A assuming that the ground voltage is applied to the X electrode and the second end of the panel capacitor Cₚ and that the panel capacitor is charged by the predetermined charge.

As shown in FIG. 8, the driving circuit according to a first exemplary embodiment includes a transistor SW₁, a capacitor C_{d1}, a resistor R₁₁, diodes D₁₁, D₂₁, and a control signal voltage source V_{g1}. A drain of the transistor SW₁ is connected to the first end of the panel capacitor Cₚ (the Y electrode), and a source is connected to the first end of the capacitor C_{d1}. A second end of the capacitor C_{d1} is connected to the ground 0. The control signal voltage source V_{g1} is connected between a gate of the transistor SW₁ and the ground 0, and supplies a control signal S_{g} to the gate of the transistor SW₁.

The diode D₁₁ and the resistor R₁₁ is connected between the first end of the capacitor C_{d1} and the control signal voltage source V_{g1}, and forms a discharging path allowing the capacitor C_{d1} to be discharged. The diode D₂ is connected between the ground 0 and the gate of the transistor SW₁, and clamps the gate voltage of the transistor SW₁. Further, a resistor (not shown) may be additionally connected between the control signal voltage source V_{g1} and the transistor SW₁, and a resistor (not shown) may be also connected between the gate of the transistor SW₁ and the ground 0.

Next, an operation of the driving circuit of FIG. 8 will be described with reference to FIG. 9.

As shown in FIG. 9, the control signal S_{g} supplied by the control signal voltage source V_{g1} alternately has a high level voltage V_{cc} for turning on the transistor SW₁, and a low level voltage Vₛₛ for turning off the transistor SW₁.

First, when the control signal S_{g} becomes the high level voltage so as to turn on the transistor SW₁, the charges accumulated to the panel capacitor Cₚ are moved to the capacitor C_{d1} When the capacitor C_{d1} is charged, the first end voltage of the capacitor C_{d1} rises so that the source voltage of the transistor SW₁ rises. At this time, the gate voltage of the transistor SW₁ is maintained to the voltage at the time of turning on the transistor SW₁, but the first end voltage of the capacitor C_{d} rises. Therefore, the source voltage of the transistor SW₁ rises as compared to the gate voltage of the transistor SW₁. When the source voltage of the transistor SW₁ rises to a predetermined voltage, the voltage between the gate and the source (referred to as the gate-source voltage hereinafter) of the transistor SW₁ is lower than the threshold voltage Vₜ of the transistor SW₁ so that the transistor SW₁ is turned off.

That is, the transistor SW₁ is turned off when the difference between the high level voltage of the control signal S_{g} and the source voltage of the transistor SW₁ is lower than the threshold voltage Vₜ of the transistor M1. When the transistor SW₁ is turned off, the voltage applied to the panel capacitor Cₚ is stopped so that the panel capacitor Cₚ is floated. And, the amount of charges ΔQᵢ accumulated in the capacitor C_{d} is given as Equation 14 when the transistor SW₁ is turned off. In this time, the voltage of the panel capacitor Cₚ can be immediately reduced by the predetermined voltage to float the panel capacitor Cₚ because movement of the charges from the panel capacitor Cₚ to the capacitor Cd are occurred simultaneously with turn-on of the transistor SW₁. And the transistor SW₁ is still turned off when the control signal S_{g} is the low level.
ΔQᵢ=C_{d}(V_{cc}−Vₜ) Equation 14
where Vₜ is the threshold voltage of the transistor SW₁, and C_{d} is the capacitance of the capacitor C_{d1}.

And, the voltage reduction ΔVₚᵢ of the panel capacitor Cₚ is given as Equation 15 since the charges ΔQᵢ charged in the capacitor C_{d1} are supplied from the panel capacitor Cp.

$$Δ {V}_{pi} = \frac{Δ {Q}_{i}}{{C}_{p}} = \frac{{C}_{d}}{{C}_{p}} ( {V}_{cc} - {V}_{t} ) \qquad Equation 15$$

where Cₚ is the capacitance of the panel capacitor Cₚ.

Next, when the control signal becomes the low level, the capacitor C_{d1} is discharged through the path including the capacitor C_{d1}, the diode D₁₁, the resistor R₁₁ and the control signal voltage source V_{g1} since the first end voltage of the capacitor C_{d1} is higher than the positive polarity voltage of the control signal voltage source V_{g1}. Because the capacitor C_{d1} is discharged in the state that the capacitor C_{d1} is charged to (V_{cc}−Vₜ) voltage, the amount ΔV_{d} of the reduced voltage of the capacitor C_{d1} by the discharge is given as Equation 16.

$$Δ {V}_{d} = ( {V}_{cc} - {V}_{t} ) {ⅇ}^{- \frac{1}{{R}_{1} {C}_{d}} t} \qquad Equation 16$$

where R₁ is the resistance of the resistor R₁₁.

In addition, the amount of charges ΔQ_{d} discharged from the capacitor Cd is given as Equation 17 according to the low level time T_{off} of the control signal. Therefore, the amount of charges Q_{d} remaining in the capacitor C_{d1} is given as Equation 18.

$$\begin{matrix}Δ {Q}_{d} = {C}_{d} ( {V}_{cc} - {V}_{t} ) - {C}_{d} ( {V}_{cc} - {V}_{t} ) {ⅇ}^{- \frac{1}{{R}_{1} {C}_{d}} {T}_{off}} \\ = {C}_{d} ( {V}_{cc} - {V}_{t} ) ( 1 - {ⅇ}^{\frac{1}{{R}_{1} {C}_{d}} {T}_{off}} )\end{matrix} \qquad Equation 17$$

Q_{d}=ΔQᵢ−ΔQ_{d} Equation 18

Next, when the control signal becomes the high level voltage again, the transistor SW₁ is turned on so that the charges are moved from the panel capacitor Cₚ to the capacitor C_{d1}. As described above, the transistor SW₁ is turned off when the capacitor C_{d1} is charged to the charges ΔQᵢ. Therefore, the transistor SW₁ is turned off when the charges ΔQᵢ are moved from the panel capacitor Cₚ to the capacitor C_{d1}. As a result, the amount ΔVₚ of the reduced voltage of the panel capacitor Cₚ is given as Equation 19.

$$Δ {V}_{p} = \frac{Δ {Q}_{d}}{{C}_{p}} = \frac{{C}_{d}}{{C}_{p}} ( {V}_{cc} - {V}_{t} ) ( 1 - {ⅇ}^{- \frac{1}{{R}_{1} {C}_{d}} {T}_{off}} ) \qquad Equation 19$$

As described above, when the voltage of the panel capacitor Cₚ is reduced by ΔVₚ voltage, the voltage of the capacitor C_{d1} rises so that the transistor SW₁ is turned off. When the control signal S_{g} becomes the low level voltage, the capacitor C_{d1} is discharged, and the transistor SW₁ maintains the turn-off state. Therefore, reducing the voltage of the panel capacitor Cₚ in response to the high level of the control signal S_{g} and floating the panel capacitor Cₚ in response to rising of the voltage of the capacitor C_{d1} is repeated. That is, a falling ramp voltage can be applied to the electrode, so that the voltage falls and the electrode is then floated.

Further in contrast with the fourth exemplary embodiment of the present invention, the discharge path may not be connected to the control signal voltage source V_{g} but can be formed by the different path. For example, a switching element is connected between the first end of the capacitor Cₚ and the ground 0 to form the discharge path. In this case, the switching element is turned on during the discharging time T_{off} of the capacitor Cₚ.

Furthermore, referring to Equation 19, the amount of the reduced voltage of the panel capacitor Cₚ can be controlled by controlling a duty ratio of the control signal S_{g}, since the reduced voltage of the panel capacitor Cₚ is determined by the resistor R₁₁ and the low level period T_{off} of the control signal S_{g}. Meanwhile, the amount of the reduced voltage of the panel capacitor Cₚ can be controlled using variable resistor as R₁₁.

Further, the resistor or inductor can be connected between the panel capacitor Cₚ and the transistor SW1 so as to restrict the amount of the current discharged from the panel capacitor Cₚ.

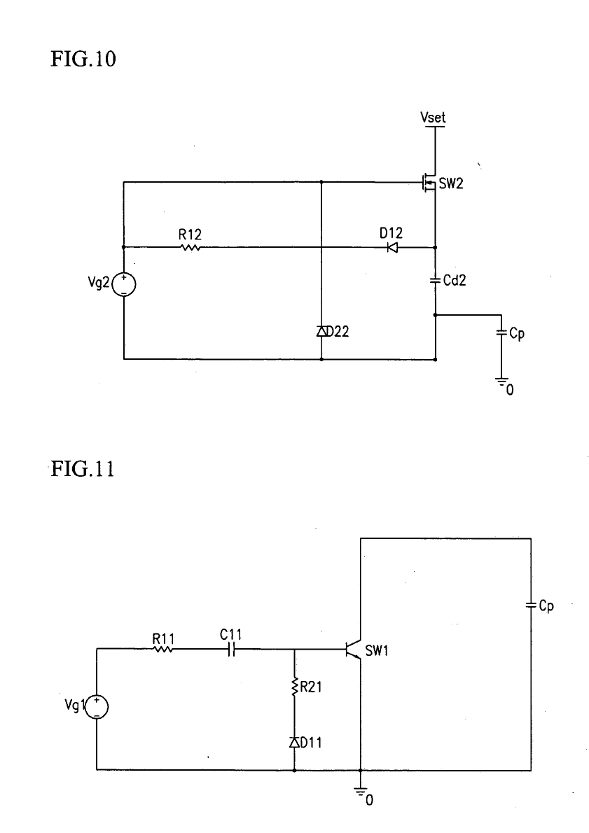

In FIGS. 8 and 9, the process for discharging the voltage charged in the panel capacitor Cₚ so as to generate the falling waveform of FIG. 3, is explained. However, this process may be applied to processes for charging voltage to the panel capacitor Cₚ to cause a rising waveform. Hereinafter, this exemplary embodiment will be explained referring to FIG. 10.

FIG. 10 shows a brief circuit diagram of the driving circuit according to the fifth exemplary embodiment. As shown in FIG. 10, in contrast with FIG. 5, a drain of the transistor SW₂ is coupled with the power source supplying high voltage Vₛₑₜ, the capacitor C_{d2} is connected between a source of the transistor SW₂ and the first end of the panel capacitor Cₚ, in the driving circuit according to the fifth exemplary embodiment. The capacitor C_{d2} and the panel capacitor Cₚ is charged by the Vₛₑₜ voltage, when the transistor SW₂ is turned on by high level control signal S_{g} of the control signal voltage source V_{g2}. In this time, since the capacitor C_{d2} and the panel capacitor Cₚ is connected in series, the voltage charged in the capacitor C_{d2} and the panel capacitor Cₚ is determined by the amount of the capacitor C_{d2} and the panel capacitor Cₚ. As explained in above, the voltage charged in capacitor C_{d2} and the panel capacitor Cₚ is enough to turn off the transistor SW₂ by the voltage charged in the capacitor C_{d2}. Next, the capacitor C_{d2} is discharged by the low level control signal S₈. And when the control signal S_{g} is high level, this operation is repeated so that a rising waveform in which voltage rises and electrode is floated alternatively can be supplied to the Y electrode. The detailed explanation for the operation of the circuit shown in the FIG. 10 can be easily understood from the explanation of FIGS. 8, 9 and 10, thus is omitted.

A waveform that repeats floating using the capacitor C_{d1}, C_{d2} is shown in FIGS. 8 to 10; however the current which is supplied to the control end of the transistor SW₁, SW₂ can be restricted. Hereinafter, such exemplary embodiment will be explained in detail referring to FIGS. 11, 12 and 13.

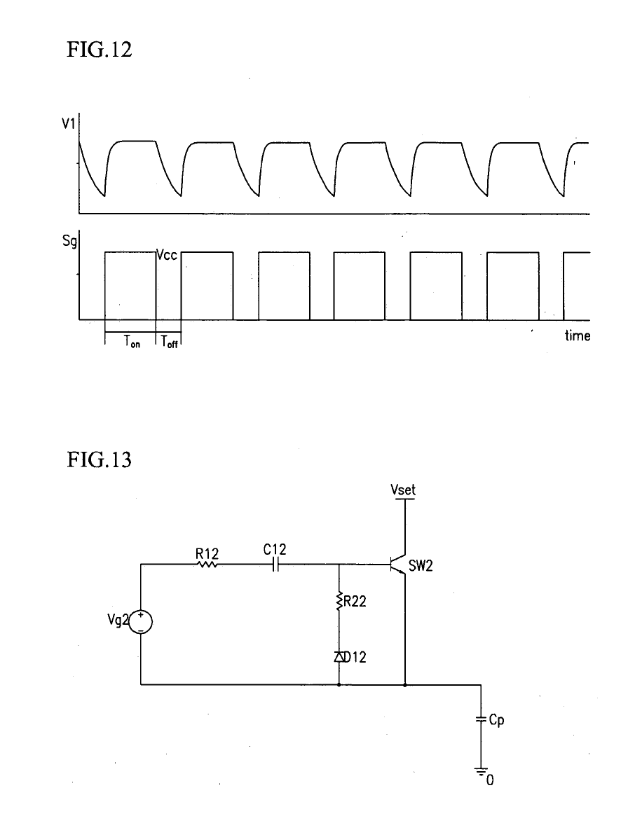

FIG. 11 shows a brief circuit diagram of the driving circuit according to a sixth exemplary embodiment. FIG. 12 shows the relation between the control signal and the voltage of the capacitor in FIG. 11.

As shown in FIG. 11, the driving circuit according to the sixth exemplary embodiment includes a transistor SW₁, a capacitor C₁₁, a resistor R₁₁, a diode D₁₁ and the control signal source V_{g1}. The transistor SW₁ is a bipolar transistor wherein one of the main end, collector is coupled with the first end (Y electrode) of the panel capacitor Cₚ, and other main end, emitter is coupled with the standard voltage. FIG. 11 assumes that the standard voltage is the ground voltage. And the second end of the panel capacitor Cₚ also is coupled with the ground voltage. A base, a control end of the transistor SW₁ is coupled with the first end of the capacitor C₁₁, and the second end of the capacitor C₁₁ is coupled with resistor R₁₁. Positions of the capacitor C₁₁ and resistor R₁₁ can be exchanged. The control signal source V_{g} is coupled between the resistor R₁₁ and the standard voltage to supply the control signal S_{g} to the transistor SW₁. And the diode D₁₁ is coupled between the standard voltage and the base of the transistor SW₁ to form a discharge path in which the capacitor C₁₁ can be discharged. Further, a resistor R₂₁ can be inserted in path including D₁₁.

Next, an operation of the driving circuit of FIG. 11 will be explained in detail referring to FIG. 12. For convenience, it is assumed that a discharge doses not occur in the waveform of FIG. 11. If a discharge occurs, the waveform of FIG. 11 would be shown as the waveform of the FIG. 3 in which the voltage increases during the period of the floating.

As shown in FIG. 12, the control signal S_{g} supplied from the control signal source V_{g1} alternatively has a high level voltage V_{cc} for turn-on of the transistor SW₁ and a low level voltage Vₛₛ for turn-off of transistor SW₁.

In one embodiment, the current is first supplied to the base of the transistor SW₁ so that transistor SW₁ turns on when the high level control signal S_{g} is supplied from the control signal source V_{g1}. Then the current corresponding to the current supplied to the base of the transistor SW₁ is discharged to the ground voltage via the transistor SW₁ from the panel capacitor Cₚ, thus the voltage of the panel capacitor Cₚ is decreased. And as shown in FIG. 12, the capacitor C₁₁ is charged by the high level control signal S_{g}. The current supplied to the base of the transistor SW₁ is small, and the transistor SW₁ is turned off when the voltage V₁ charged in the capacitor C₁₁ is essentially identical with the high level voltage V_{cc} of the control signal S_{g}. In this condition, the time that the voltage charged to capacitor C₁₁ remains identical to the voltage V_{cc}, will be determined by the amount of the capacitor C₁₁ and the resistor R₁₁. As such, when the transistor SW₁ is turned off, the second end of the panel capacitor Cₚ, and the Y electrode are floated.

And, when the amount of the capacitance of the capacitor C₁₁ and/or the amount of resistor R₁₁ can be properly set, the period Tᵣ in which the voltage of the panel capacitor Cₚ falls can be controlled to be shorter than the period Ton in which the control signal S_{g} is maintained in high level. That is, the transistor SW₁ can be turned off and the panel capacitor Cₚ can be floated before a low level of the control signal S_{g}. Also, while the control signal S_{g} is at a high level, the voltage of the capacitor C₁₁ is continuously maintained at a high level voltage V_{c}. And, when the control signal S_{g} is at a low level, the voltage charged in capacitor C₁₁ is discharged via the discharge path formed by the diode D¹¹. Thus the voltage V₁ of the capacitor C₁₁ is reduced as shown in FIG. 12. Further, while the voltage V₁ of the capacitor C₁ is discharged, current is not supplied to the base of the transistor SW₁, so that the transistor SW₁ is continuously turned off.

Next, when the control signal S_{g} is again at a high level, the transistor SW₁ is turned on, and the panel transistor Cₚ is discharged. When the capacitor C₁₁ is charged to the high level voltage V_{cc} of the control signal S_{g}, the transistor SW₁ is turned off and the panel capacitor Cₚ is floated. And, when the control signal S_{g} is at a low level, the capacitor C₁₁ is discharged in the condition that the transistor SW₁ is turned off. As such, while the control signal S_{g} is converted between high level and low level, the panel capacitor Cₚ repeats the falling voltage and floating condition.

That is, in driving circuit according to the sixth exemplary embodiment, the voltage of the capacitor Cₚ is decreased in response to a high level of the control signal S_{g}, the panel capacitor Cₚ is floated in response to the charged voltage of the capacitor C₁₁, the capacitor C₁₁ is discharged in response to a low level of the control signal S_{g}, to generate the waveform of FIG. 3.

Further, the period of floating can be controlled regardless of the frequency of the control signal S_{g} in the sixth exemplary embodiment, since transistor SW₁ is turned off while the high level of the control signal S_{g}, and since the period of turn on of transistor SW₁ is determined by the amount of a resistor R₁₁ and capacitor C₁₁. The amount discharged from the capacitor C₁₁ can be controlled by controlling the period T_{off} when the control signal S_{g} is maintained at a low level. Thus the period when the capacitor C₁₁ is charged to the V voltage, and transistor SW₁ is turned on, can be controlled. Also, the amount discharged from capacitor C₁₁ can be controlled by controlling the amount of resistor R₂₁ in the discharge path formed by diode D₁₁.

And, the discharge path of the sixth exemplary embodiment can be formed in the other path without being connected to the cathode of the control signal source V_{g1}.

Also, the sixth exemplary embodiment explains a process where the voltage of the panel capacitor Cₚ falls. However the driving circuit of the FIG. 11 applies to a process where the voltage of the panel capacitor Cₚ rises.

The FIG. 13 shows a brief circuit diagram of driving circuit according to a seventh exemplary embodiment. As shown in FIG. 13, the driving circuit according to the seventh exemplary embodiment has a similar construction to FIG. 11 except for the connection condition of the transistor SW₂. For example, a collector of a transistor SW₂ is coupled with Vₛₑₜ voltage, and a emitter of the transistor SW₂ is coupled with the first end of the panel capacitor.

When a control signal S_{g} of the control signal source V_{g2} is high level and the transistor SW₂ is turned on, the panel capacitor Cₚ is charged by the Vₛₑₜ voltage so that the voltage of the panel capacitor Cₚ increases. When the voltage V₁ of the capacitor C₁₂ approximately reaches the high level voltage V₁, the transistor SW₂ turns off and the panel capacitor Cₚ is floated. And, when the control signal S_{g} is at a low level, the voltage of the capacitor C₁₂ is discharged. Then when the control signal S_{g} is again at a high level, the transistor SW₂ is turned on, and the above operation is repeated.

As such, a floating waveform after raising a voltage of the electrode can be generated according to the driving circuit of the FIG. 13. The detailed operation of driving circuit of FIG. 13 and a driving waveform diagram thereof can be easily understood from FIGS. 11 and 12 and is omitted.

Also NPN type bipolar transistors as transistors SW₁ and SW₂ are showed in FIGS. 11 and 13, however the PNP type bipolar transistor as transistor SW₁ and SW₂ can be used, and circuit construction in that time, can be easily understood by an ordinary person in the art; thus detailed explanation is omitted. Further other switching elements can be used, which determine turn on/turn off according to the current applied to the control end of the bipolar transistor.

However, a waveform repeating floating is generated by controlling the current supplied to the control end of the transistor by the capacitor C₁ in FIGS. 11, 12 and 13, otherwise, a gate voltage of the transistor SW₁ can be controlled. Hereinafter, such exemplary embodiment will be explained in detail referring to FIGS. 12, 14 and 15.

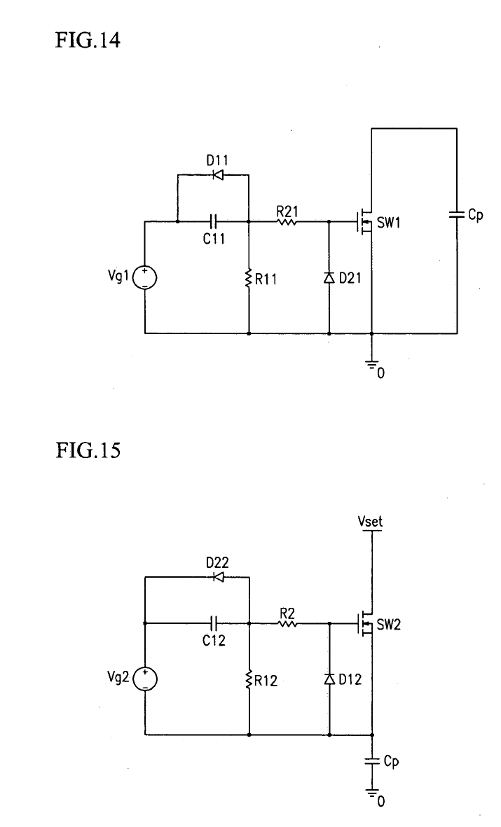

FIG. 14 shows a brief circuit diagram of the driving circuit according to an eighth exemplary embodiment.

As shown in FIG. 14, the driving circuit of the eight exemplary embodiment includes transistor SW₁, capacitor C₁₁, resistor R₁₁ and the control signal source V_{g1}. The control signal source V_{g1} supplies the control signal S_{g} to the transistor SW₁, which is connected between the gate of the transistor SW₁ and the source of the transistor SW₁. The drain of the transistor SW₁ is coupled with the first end of the panel capacitor, and the source is coupled with the ground (0), such that a parasitic capacitance element C_{g} is formed. A capacitor C₁₁ is connected between the gate of transistor SW₁ and the control signal source V_{g1}, and a resistor R₁₁ is connected between the capacitor C₁₁ and the source of the transistor SW₁. The capacitor C₁₁ and the resistor R₁₁ form a RC circuit and are applied as control circuit of the gate voltage controlling the gate voltage of the transistor SW₁.

Further, a resistor R₂₁ can be further connected between the capacitor C₁ and the transistor SW₁. A diode D₁₁ can be connected between the source and the gate of the transistor SW₁, and the gate voltage of the transistor SW₁ can be clamped so that the gate voltage of the transistor SW₁ does not fall below the standard voltage of the control signal source V_{g1}. Further, the diode D₂₁ can be formed in parallel with capacitor C₁₁, and the gate voltage of the transistor SW₁ can be clamped so that the gate voltage of the transistor SW₁ does not rise beyond the voltage of the control signal source.

Next, an operation of the driving circuit of FIG. 15 will be explained in detail referring to FIG. 12. Here the resistor R₂₁ and diodes D₁₁, and D21 are not explained in the circuit of FIG. 15, because their operation has been previously described.

As shown in FIG. 12, the control signal S_{g} supplied from the gate voltage source V_{g} has alternatively a high level voltage V_{cc} to turn on the transistor SW₁ and a low level voltage Vₛₛ to turn off the transistor SW₁.

First, when the control signal S_{g} is at a high level voltage V_{cc} to turn on the transistor SW₁, the equation 20 is given from a capacitor C₁₁, resistor R₁₁, a capacitance element C_{g} of the transistor SW₁ and the gate voltage V₂(t) of the transistor SW₁.

$${C}_{1} \frac{ⅆ {V}_{2} ( t )}{ⅆ t} + \frac{{V}_{2} ( t )}{{R}_{1}} + {C}_{g} \frac{{V}_{2} ( t )}{dt} = 0 \qquad Equation 20$$

Here, C₁ and C_{g} is a capacitor C₁₁ and capacitance of the capacitance element C_{g} each, R₁ is a resistor value of the resistor R₁₁.

Once the control signal S_{g} is at a high level, that is, t=0, the gate voltage V₂(0) of the transistor SWᵢ is identical with V_{cc}. Thus the gate voltage V₂(t) is given as equation 21 from the equation 20.

$${V}_{2} ( t ) = \frac{{C}_{1}}{{C}_{1} + {C}_{g}} {V}_{cc} {ⅇ}^{- \frac{1}{{R}_{1} ( {C}_{1} + {C}_{g} )} t} \qquad Equation 21$$

The transistor SW₁ is turned on when the gate-source voltage is larger than the threshold voltage Vt of the transistor SW₁. Also, the source of the transistor SW₁ is coupled with the ground, thus the gate-source voltage of the transistor SW₁ is identical with gate voltage V₂(t). Therefore, the equation 22 is given from the gate voltage V₂(t) of transistor SW₁ and the threshold voltage (Vₜ), thus period Tᵣ in which the transistor is turned on, is given as equation 23.

$$\begin{matrix}\frac{{C}_{1}}{{C}_{1} + {C}_{g}} {V}_{cc} {ⅇ}^{- \frac{1}{{R}_{1} ( {C}_{1} + {C}_{g} )} t} > {V}_{t} & Equation 22 \\ {T}_{r} = {R}_{1} ( {C}_{1} + {C}_{g} ) ln \frac{{C}_{1} {V}_{cc}}{{V}_{t} ( {C}_{1} + {C}_{g} )} & Equation 23\end{matrix}$$

Here, during the period Tᵣ, the transistor SW₁ is turned on, the panel capacitor Cₚ is discharged and the voltage of the panel capacitor Cₚ is reduced. That is, the falling period of the voltage of the panel capacitor is same with the period Tᵣ when the transistor SW₁ is turned on. And, the decreased amount (ΔVₚ) of the voltage of the panel capacitor Cₚ is determined depending on the period Tᵣ when the transistor SW₁ is turned on. A short falling period Tᵣ of the voltage is preferable to precisely control the amount of wall charge. The period Tᵣ, when the transistor SW₁ is turned on can be shortened comparative to the high level period Tₒₙ of the control signal.

And, when a Tᵣ time passes, the gate voltage V₂(t) of the transistor SW₁ is smaller than a threshold voltage Vₜ, so that the transistor SW₁ is turned off, even if the control signal S_{g} is at a high level voltage V_{cc}. Further, the transistor SW₁ is maintained in a turned off condition when the control signal S_{g} is at a low level voltage Vₛₛ. As such, the first end of the panel capacitor Cₚ is floated when the transistor SW₁ is turned off. That is, the floating time T_{f} is defined from the time the gate voltage V₂(t) of the transistor SW₁ is smaller than the threshold voltage Vₜ to the time T_{off} the control signal S_{g} is maintained in low level voltage Vₛₛ.

Next, the transistor SW₁ is turned on and the voltage of the panel capacitor Cₚ falls when the control signal S_{g} is again at a high level voltage V_{cc}. The transistor SW₁ is turned off when the gate voltage of the transistor SW₁ falls as noted in equation 21, and is smaller than the threshold voltage. And the transistor SW₁ is maintained in turned off condition when the control signal S_{g} is at a low level voltage Vₛₛ. As such, the period Tᵣ, when the voltage of the panel capacitor Cₚ falls in response to the high level voltage V_{cc} of the control signal S_{g}; and the period T_{f} when the panel capacitor Cₚ is floated according to reduction of gate voltage V₂ of the transistor SW₁, are continuously repeated. Thus, the falling ramp voltages have a repeated falling voltage and floating can be applied to the electrode.

Also, referring to equation 23, the period T_{f}, when the transistor SW₁ is turned on is determined by amount of resistor R₁₁ and capacitor C₁₁. Thus the turn on period Tᵣ can be controlled by the resistor R₁₁ and capacitor C₁₁. Particularly, the turn on period Tᵣ can be set using a variable resistor as the resistor R₁₁. For example, when the resistor R₁₁ is large, the turn on period Tᵣ of the transistor SW₁ is enlarged, and the amount (ΔVₚ) that the voltage of the panel capacitor Cₚ is decreased is enlarged. And, instead of resistor R₁₁, an inductor can be used to control the gate voltage of the transistor SW₁. Further, resistor or inductor can be connected between the drain of the transistor SW₁ and the panel capacitor Cₚ so as to restrict the current discharged from the panel capacitor Cₚ.

As such, the eighth exemplary embodiment shows the driving circuit generating a falling ramp voltage having a repeated falling voltage and floating. Also, a driving circuit generating a rising ramp voltage having a repeated rising voltage and floating will be explained in detail referring to FIG. 15, which shows a brief circuit diagram of the driving circuit according to a ninth exemplary embodiment.

As shown in FIG. 15, the driving circuit of the ninth exemplary embodiment is different from the eight exemplary embodiment in the connection between transistor SW₂ and the panel capacitor Cₚ. That is, the source of the transistor SW₂ is coupled with the first end of the panel capacitor Cₚ, and the ground (0) is coupled with the second end of the panel capacitor Cₚ. Also, the drain of the transistor SW₂ is coupled with the power source supplying the higher voltage Vₛₑₜ than the first end of the panel capacitor Cₚ. Other are connected as the eighth exemplary embodiment.

As explained in the eighth exemplary embodiment, the panel capacitor Cₚ is charged by Vₛₑₜ voltage in the period Tᵣ, and the transistor SW₂ is turns on when the control signal S_{g} of the control signal source V_{g2} is at a high level voltage V_{cc}. In this time, the increased amount charge of the voltage ΔVₚ is proportional to the turn on period Tᵣ of the transistor SW₂. And, when the gate voltage V₂(t) of the transistor SW₂ is decreased by the RC circuit including the capacitor C₁₂ and resistor R₁₂, the gate-source voltage of the transistor SW₂ is smaller than the threshold voltage Vₜ of the transistor SW₂, so that the transistor SW₂ is turned off. Next, when the control signal S_{g} is low level voltage Vₛₛ, the transistor SW₂ is maintained in the turn off condition.

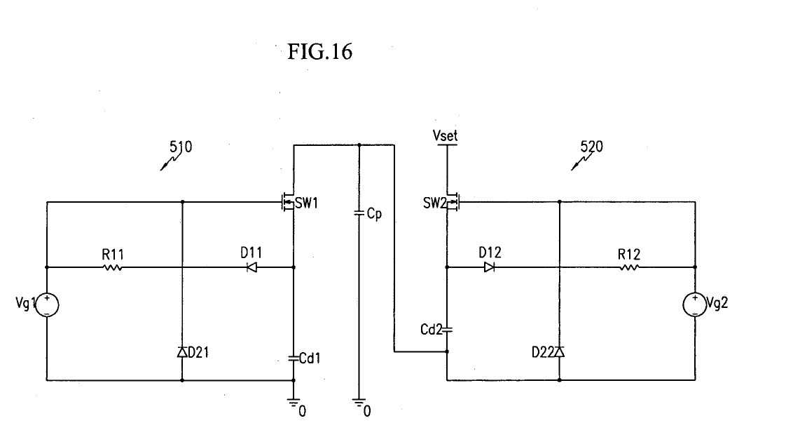

As such, FIGS. 8, 9, 10, 11, 12, 13, 14 and 15 show a driving circuit generating the falling waveform of FIG. 3 and the rising waveform of FIG. 3. As explained in above, the circuit generating falling waveform can repeat floating operation voltage after the voltage falls by the predetermined voltage; the circuit generating rising waveform can repeat floating operation voltage after raising the voltage to the predetermined voltage; thus, the waveform of FIGS. 6 and 7 can be generated using the two circuits. Hereinafter such exemplary embodiment will be explained in detail referring to FIG. 16, which shows a brief circuit diagram of the driving circuit of a tenth exemplary embodiment.

As shown in FIG. 16, the driving circuit of the tenth exemplary embodiment includes a falling waveform generating circuit (510) and a rising waveform generating circuit (520). FIG. 16 shows the circuit of the FIG. 8 as a falling waveform generating circuit (510) and the circuit of the FIG. 10 as a rising waveform generating circuit (520).

Referring to FIG. 16, the first end of the panel capacitor Cₚ is coupled with a drain of the transistor SW₁ in the falling waveform generating circuit (510) and the second end of the capacitor C_{d2} in the rising waveform generating circuit (520). Other connections have identical construction with the circuits of FIGS. 8 and 10, thus the detailed explanation is not described.

Hereinafter, the method generating the waveforms of the FIGS. 6 and 7 by using the circuit of FIG. 16 will be explained.

When the transistor SW₂ is turned off, the transistor SW₁ is turned on by the control signal voltage source V_{g1}. Then, while the voltage of the panel capacitor Cₚ falls, the voltage is charged to the capacitor C_{d1}. When the predetermined voltage is charged to the capacitor C_{d1}, the transistor SW₁ is turned off, and the panel capacitor Cₚ is floated. That is, the falling voltage and floating are operated.

Next, the transistor SW₂ is turned on by the control signal source V_{g2}. Then, the voltage of the panel capacitor Cₚ is raised by the Vₛₑₜ voltage, the voltage is charged to the capacitor C_{d2}. When the predetermined voltage is charged to the capacitor C_{d2}, the transistor SW₂ is turned off and the panel capacitor Cₚ is floated. That is, the rising voltage and floating are operated.

As such, the falling voltage and floating are operated during the period from turn on of the transistor SW₁ to turn on of the transistor SW₂, and the rising voltage and floating are operated during the period between from turn on of the transistor SW₂ to turn on of the transistor SW₁. Thus, waveforms of FIGS. 6 and 7 can be generating by repeating such operations.

In this time, the falling waveform of FIG. 6 is generated, when a range of the falling voltage of the panel capacitor Cₚ is larger than range of the rising voltage, by controlling an amount of the capacitor C_{d1} and C_{d2}. The rising waveform of FIG. 7 is generated when the range of falling voltage of the panel capacitor Cₚ is smaller than a range of the rising voltage.

As such, waveforms of FIGS. 6 and 7 can be generated by repeating operations of falling waveform generating circuit (510) and rising waveform generating circuit (520). Although FIG. 16 was explained referring to circuits of the FIGS. 8 and 10, the circuit of FIG. 16 can be constructed using other circuits explained in above or other circuits, which have similar function.

Methods of floating the scan electrode are mainly described in the above-noted exemplary embodiments of the present invention, and however the present invention can be used to all methods of floating one of the electrodes at a discharge cell including a scan electrode, a sustain electrode, and an address electrode.

According to the present invention, the wall charge formed in discharge cell can be finely controlled by repeatedly floating an electrode after discharging.

While this invention has been described in connection with what is presently considered to be the most practical and exemplary embodiment, it is to be understood that the invention is not limited to the disclosed embodiments, but, on the contrary, is intended to cover various modifications and equivalent arrangements included within the spirit and scope of the appended claims.

1. A method of driving a plasma display panel having a discharge space formed by at least two electrodes, comprising in a reset period:
changing a voltage of the first electrode by a first voltage, to discharge a discharge space;
floating a first electrode during a first period after changing the voltage of the first electrode by the first voltage;
changing the voltage of the first electrode by a second voltage in an opposite direction of the first voltage after the first period;
floating the first electrode during the second period after changing the voltage of the first electrode by the second voltage.

2. The method of claim 1, further comprising repeating the method a predetermined number of times.

3. The method of claim 1, wherein an absolute value of the first voltage is larger than an absolute value of the second voltage.

4. The method of claim 1, wherein the voltage of the first electrode increases by the first voltage, and the voltage of the first electrode decreases by the second voltage.

5. The method of claim 1, wherein the voltage of the first electrode decreases by the first voltage, and the voltage of the first electrode increases by the second voltage.

6. A method of driving a plasma display panel having a discharge space formed by at least two electrodes, comprising:
changing the voltage of the first electrode of electrodes forming the discharge space by the first voltage;
floating the first electrode; and
changing the voltage of the first electrode by a second voltage.

7. The method of claim 6, wherein an absolute value of the first voltage is larger than an absolute value of the second voltage.

8. The method claim 7, further comprising repeating the method a predetermined number of times.

9. The method of claim 7, further comprising floating the first electrode after changing the voltage of the first electrode by the second voltage.

10. The method of claim 9, further comprising repeating the method a predetermined number of times.

11. The method of claim 6, wherein the first electrode is a scan electrode.

12. The method of claim 6, wherein the remaining electrodes forming the discharge space are biased by a constant voltage.

13. The method of claim 6, wherein the first voltage is a positive voltage, and the second voltage is a negative voltage.

14. The method of claim 6, wherein the first voltage is a negative voltage, and the second voltage is a positive voltage.

15. The method of claim 6, wherein the first voltage is a constant voltage.

16. The method of claim 6, wherein the first voltage is time-variant voltage.

17. A driving device of the plasma display panel having discharge space formed by at least two electrodes acting as a capacitive load, comprising:
a first driving circuit reducing the voltage of a first electrode in electrodes forming the capacitive load by a first voltage, then floating the first electrode; and
a second driving circuit increasing the voltage of the first electrode by a second voltage, then floating the first electrode,
wherein the first driving method and the second driving circuit is operated by turns.

18. The driving device of claim 17, wherein an absolute value of the first voltage is larger than an absolute value of the second voltage.

19. The driving device of claim 17, wherein an absolute value of the second voltage is larger than an absolute value of the first voltage.

20. The driving device of claim 17, wherein the first driving circuit comprises a first transistor having its first end coupled to the first electrode and its second end coupled to a first power source supplying a third voltage; and
wherein the second driving circuit comprises a second transistor having its first end coupled to a second power source supplying a fourth voltage higher than the third voltage and its second end coupled to the first electrode,
wherein the voltage of the first electrode is between the third voltage and fourth voltage in a given time period.

21. The driving device of claim 20, wherein during a first period in which the second transistor is turned off, the first transistor is turned on so that the voltage of the first electrode decreases to the first voltage, after which the first transistor is turned off; and
wherein during a second period in which the first transistor is turned off, the second transistor is turned on so that the voltage of the first electrode increases to the second voltage, after which the second transistor is turned off, and wherein these time periods are alternatively repeated.

22. The driving device of claim 21, wherein the first transistor is turned on in response to a first level of a control signal having the first level and a second level alternately; and
wherein the first driving circuit further comprises:
a capacitor which is coupled between the second end of the first transistor and the first power source, and receives a charge from the first electrode when the first transistor is turned on; and
a discharge path which discharges at least a portion of charge charged to the capacitor in response to the second level of the control signal,
wherein the first transistor is turned off when the voltage of the first electrode is reduced by the first voltage and a predetermined charge is charged to the capacitor.

23. The driving device of claim 21, wherein a second transistor is turned on in response to a first level of a control signal having the first level and a second level alternately; and
wherein the second driving circuit further comprises:
a capacitor which is coupled between the second end of the second transistor and the first electrode and receives a charge from the second power source when the second transistor is turned on; and
a discharge path which discharges at least a portion of charge charged to the capacitor in response to the second level of the control signal,
wherein the second transistor is turned off when the voltage of the first electrode rises by the second voltage and a predetermined charge is charged to the capacitor.

24. The driving device of claim 21, wherein the first transistor is turned on in response to a first level of a control signal having the first level and a second level alternately; and
wherein the first driving circuit further comprises:
a capacitor which is coupled between an input end to which the control signal is inputted and a control end of the first transistor;
a resistor formed in a path including the input end, the capacitor and the control end of the first transistor; and
a discharge path which discharges voltage charged to the capacitor in response to the second level of the control signal, and
wherein the first transistor is turned off when the predetermined voltage is charged to the capacitor by the first level of the control signal.

25. The driving device of claim 21, wherein the second transistor is turned on in response to a first level of a control signal having the first level and a second level alternately; and
wherein the second driving circuit further comprises:
a capacitor which is coupled between an input end to which the control signal is inputted and the control end of the second transistor;
a resistor formed in a path including the input end, the capacitor and the control end of the second transistor; and
a discharge path which discharges voltage charged to the capacitor in response to the second level of the control signal,
wherein the second transistor is turned off when the predetermined voltage is charged to the capacitor by the first level of the control signal.

26. The driving device of claim 21, wherein the first transistor is turned on in response to a first level of a control signal having the first level and a second level alternately; and
wherein the first driving circuit further comprises:
a capacitor which is coupled between an input end to which the control signal is inputted and the control end of the first transistor; and
at least one element of a resistor and an inductor formed in path including the input end, the capacitor, and the control end of the first transistor,
wherein the first transistor is turned off when the predetermined voltage is charged to the capacitor by the first level of the control signal.

27. The driving device of claim 21, wherein the second transistor is turned on in response to a first level of a control signal having the first level and a second level alternately; and
wherein the second driving circuit further comprises:
a capacitor which is coupled between an input end to which the control signal is inputted and the control end of the first transistor; and
at least one element of a resistor and an inductor formed in a path including the input end, the capacitor, and the control end of the second transistor,
wherein the second transistor is turned off when the predetermined voltage is charged to the capacitor by the first level of the control signal.
